(19) United States
(12) Patent Application Publication
(10) Pub. No.: US 2013/0215113 A1
(43) Pub. Date: Aug. 22, 2013

(54) SYSTEMS AND METHODS FOR ANIMATING THE FACES OF 3D CHARACTERS USING IMAGES OF HUMAN FACES

(71) Applicant: Mixamo, Inc., (US)

(72) Inventors: Stefano Corazza, San Francisco, CA (US); Emiliano Gambaretto, San Francisco, CA (US); Prasanna Vasudevan, San Francisco, CA (US)

(73) Assignee: Mixamo, Inc., San Francisco, CA (US)

(21) Appl. No.: 13/773,344

(22) Filed: Feb. 21, 2013

Related U.S. Application Data
(60) Provisional application No. 61/601,418, filed on Feb. 21, 2012.
(60) Provisional application No. 61/674,292, filed on Jul. 20, 2012.

(51) Int. Cl. G06T 13/40

(52) U.S. Cl. CPC G06T 13/40
USPC 345/420

(57) ABSTRACT

Techniques for animating a 3D facial model using images of a human face are described. An embodiment of the method of the invention involves matching an image of a human face to a point in a space of human faces and facial expressions based upon a description of a space of human faces and facial expressions obtained using a training data set containing multiple images of human faces registered to a template and multiple images of human facial expressions registered to the same template. The point in the space of human faces and facial expressions matching the human face can then be used in combination with a set of mappings from the space of human faces and facial expressions to a plurality of facial expressions for a 3D character model to deform a mesh of the 3D character model to achieve a corresponding facial expression.

### CROSS-REFERENCE TO RELATED APPLICATIONS

This application claims priority to U.S. Provisional Application No. 61/601,418 filed Feb. 21, 2012, entitled “ONLINE REAL-TIME SYSTEM FOR FACIAL ANIMATION OF CHARACTERS”, and U.S. Provisional Application No. 61/674,292 filed Jul. 20, 2012, titled “SYSTEMS AND METHODS FOR ANIMATING THE FACES OF 3D CHARACTERS USING IMAGES OF HUMAN FACES”. The disclosures of U.S. Provisional Application Nos. 61/601,418 and 61/674,292 are incorporated herein by reference in their entirety.

### FIELD OF THE INVENTION

The present invention relates generally to computer generated graphics and more specifically to generating virtual facial expressions from human facial expressions.

### BACKGROUND

The creation of computer generated 3D content is becoming popular. Computer generated 3D content typically includes one or more animations. A 3D character can be specified using a mesh of vertices and polygons that define the shape of an object in 3D. The 3D character can also have a texture applied to the mesh that defines the appearance of the mesh. 3D characters used for animations can also include a skeleton that defines the articulated body parts of the mesh as well as skinning weights that define the deformation of a mesh as a function of the motion of a skeleton. The process of defining skeleton and skinning weights is often referred to as rigging a 3D character. The animation of a rigged 3D character involves applying motion data to the character's skeleton to drive the character's mesh. The generation of animations can be technically challenging and is often performed by artists with specialized training.

Patterns within computer generated 3D content can be found utilizing Principal Components Analysis (PCA). PCA is a process that utilizes an orthogonal transformation to convert a dataset of values into a set of values of linearly uncorrelated variables called principal components. A set of values expressed in terms of the principal components can be referred to as a feature vector. A feature vector can correspond to a particular aspect of 3D generated content such as a representation of a particular pattern or to the values of the pixels of an image.

### SUMMARY OF THE INVENTION

Systems and methods in accordance with embodiments of the invention extract images of human faces from captured images, obtain a description of the face and facial expression and use the description to animate a 3D character model by deforming a 3D mesh of a face.

One embodiment includes a processor, and storage containing: a 3D character model comprising a 3D mesh including a face; a description of a space of human faces and facial expression obtained using a training data set containing multiple images of human faces registered to a template image of a human face and multiple images of human facial expressions registered to the same template image of a human face; a set of mappings from the space of human faces and facial expressions to a plurality of facial expressions for the 3D character model, where the plurality of facial expressions each represent a deformation of the mesh of the 3D character model; and a facial animation application. The facial animation application configures the processor to: receive at least one image; extract an image of a human face from an image; match an extracted image of a human face to a point in the space of human faces and facial expressions using the description of a space of human faces and facial expressions; select a facial expression for the 3D character based upon a point in the space of human faces and facial expressions matching an extracted image of a human face and the set of mappings from the space of human faces and facial expressions to the plurality of facial expressions for the 3D character model; and deform the mesh of the 3D character based upon a selected facial expression.

In a further embodiment, the storage further comprises a cascade of classifiers and the facial animation application configures the processor to extract an image of a human face from an image by using the cascade of classifiers to identify an image of a human face within the image.

In another embodiment, the description of a space of human faces and facial expressions is obtained by performing Principal Component Analysis (PCA) of a training data set containing multiple images of human faces registered to a template image of a human face and by performing PCA of multiple images of human facial expressions registered to the same template image of a human face to define a vector space of human faces and human facial expressions.

In a yet further embodiment, the facial animation application configures the processor to match an extracted image of a human face to a point in the space of human faces and facial expressions using the description of a space of human faces and facial expressions by locating a vector within the space of human faces and human facial expressions that synthesizes an image of a human that is the closest match to the extracted image of a human face in accordance with at least one matching criterion.

In yet another embodiment, the facial animation application configures the processor to parameterize the extracted image of a human face with respect to: the scale and position of the extracted image of a human face; the geometry of the extracted image of a human face; and the texture of the extracted image of a human face.

In a still further embodiment, the facial animation application configures the processor to parameterize the scale and position of the extracted image of a human face using a plurality of scalar measurements.

In yet another embodiment, the facial animation application configures the processor to parameterize the geometry of the extracted image of a human face using a vector of a chosen size of coefficients describing the subject face geometry.

In a further embodiment again, the facial animation application configures the processor to parameterize the texture of the extracted image of a human face using a vector of a chosen size of coefficients describing the subject facial texture.

In another embodiment again, synthesizing an image of a human face includes: synthesizing a facial geometry based upon the parameterization of the scale, position and geometry of the extracted image of a human face; synthesizing a facial texture on a defined reference facial geometry using an estimate of the facial texture based upon extracted image of a human face; and determining a combination of a synthesized geometry and a synthesized texture that provide the closest match to the extracted image of the human face in accordance with the at least one matching criterion.

In a further additional embodiment, the at least one matching criterion is a similarity function.

In another additional embodiment, the at least one matching criterion is a distance function.

In a still yet further embodiment, the facial animation application configures the processor to synthesize images of a human face using vectors from the space of human faces and facial expressions based upon an active appearance model generated using the training data set.

In still yet another embodiment, the storage further includes a description of a vector space of virtual facial expressions for the 3D character model obtained by performing PCA on a training data set containing a plurality of facial expressions each representing a deformation of the mesh of the 3D character model. In addition, the set of mappings from the space of human faces and facial expressions to a plurality of facial expressions for the 3D character model comprises a set of mappings from the vector space of human faces and facial expressions to the vector space of virtual facial expressions for the 3D character model.

In a still further embodiment again, the facial animation application configures the processor to: match an extracted image of a human face to a point in the space of human faces and facial expressions using the description of a space of human faces and facial expressions and perform a multiple image patches detection process to multiple image patches detection process detect a human face and facial expression; and perform a Bayesian combination of the results of matching the extracted image of a human face to a space of human faces and facial expressions and the human face and facial expression detected using the multiple image patches detection process.

In still another embodiment again, the training data set comprises a set of two dimensional images of human faces.

In a still further additional embodiment, the training data set further comprises depth maps for a plurality of the set of two dimensional images.

In still another additional embodiment, the training data set comprises multiple views of each human face.

In a yet further embodiment again, the multiple views image the human face from different angles.

In yet another embodiment again, the storage further includes: a description of a space of virtual facial expressions for the 3D character model. In addition, the set of mappings from the space of human faces and facial expressions to a plurality of facial expressions for the 3D character model comprises a set of mappings from the space of human faces and facial expressions to the space of virtual facial expressions for the 3D character model.

In a yet further additional embodiment, the space of virtual facial expressions for the 3D character model is obtained from a training data set of containing a plurality of facial expressions each representing a deformation of the mesh of the 3D character model.

In yet another additional embodiment, the facial animation application configures the processor to: receive at least one image in the form of a sequence of video frames including a first frame of video and a second frame of video; and utilize the extracted image of a human face from the first video frame to extract an image of a human face from the second video frame.

In a further additional embodiment again, the facial animation application further configures the processor to utilize the point in the space of human faces and facial expressions found to match an extracted image of a human face from the first video frame to locate a point in the space of human faces and facial expressions matching an extracted image of a human face from the second frame of video.

In another additional embodiment again, the sequence of video frames is compressed and includes motion vector information and the facial animation application configures the processor to: parameterize an extracted image of a human face with respect to the position of the extracted image of a human face in the first frame of video; and parameterize an extracted image of a human face with respect to the position of the extracted image of a human face in the second frame of video using the motion vector information.

In another further embodiment, the facial animation application configures the processor to control the deformation of the 3D mesh of the 3D character using a plurality of blend shape control parameters.

In still another further embodiment, the set of mappings from the space of human faces and facial expressions to a plurality of facial expressions for the 3D character model comprise a set of mappings from the space of human faces and facial expressions to specific configurations of the plurality of blend shape control parameters.

An embodiment of the method of the invention includes: receiving at least one image at an animation system, where a portion of the image includes an image of a human face; extracting the image of the human face from at least one received image using the animation system; matching the extracted image of a human face to a point in a space of human faces and facial expressions based upon a description of a space of human faces and facial expressions obtained using a training data set containing multiple images of human faces registered to a template image of a human face and multiple images of human facial expressions registered to the same template image of a human face using the animation system; selecting a facial expression for a 3D character based upon the point in the space of human faces and facial expressions matching the extracted image of a human face and a set of mappings from the space of human faces and facial expressions to a plurality of facial expressions for the 3D character model using the animation system, where the 3D character model comprises a 3D mesh including a face and the plurality of facial expressions in the set of mappings each represent a deformation of the mesh of the 3D character model; and deforming the mesh of the 3D character based upon the selected facial expression using the animation system.

### BRIEF DESCRIPTION OF THE DRAWINGS

FIG. 1 illustrates a system for animating the faces of 3D characters using images of human faces in accordance with an embodiment of the invention.

FIG. 2 is a flow chart illustrating a process of animating a face of a 3D character using images of a human face in accordance with an embodiment of the invention.

FIG. 3 is a flow chart illustrating a process for detecting a human face in accordance with an embodiment of the invention.

FIG. 4 illustrates a captured frame of video including a human face.

FIG. 5 illustrates the use of classifiers to detect a face within the captured frame of video shown in FIG. 4.

FIG. 6 illustrates a face isolated from within the captured frame of video shown in FIG. 4.

FIG. 7 is a flow chart illustrating a process of generating a facial expression for a 3D character in accordance with an embodiment of the invention.

FIG. 8 is a flow chart illustrating a process of performing PCA to obtain a description of the space of human faces and facial expressions in accordance with an embodiment of the invention.

FIG. 9A illustrates a training set of human faces.

FIG. 9B illustrates a training set of human facial expressions.

FIG. 10 is a flow chart illustrating a process of performing PCA to obtain a description of the space of 3D character facial expressions in accordance with an embodiment of the invention.

FIG. 11 illustrates a training set of 3D character facial expressions.

FIG. 12 is a flow chart illustrating a process for determining the feature vector that most closely matches a human face in accordance with an embodiment of the invention.

FIG. 13 illustrates a synthesized face with a geometry and facial texture found within the PCA space of human faces and facial expressions that is the best match for the isolated face shown in FIG. 6.

### DETAILED DESCRIPTION

Turning now to the drawings, systems and methods for animating the faces of 3D characters using images of human faces in accordance with embodiments of the invention are illustrated. Images of human faces can be obtained from frames of video and/or still images. In several embodiments, a facial expression is identified from an image containing a human face. The human face is isolated within the image and an appropriate facial expression is identified. In many embodiments, temporal correlation between images in a video sequence is used to improve the tracking of human faces in frames of video. The identified facial expression can then be used to apply a corresponding facial expression to the face of a 3D character or a virtual face.

In certain embodiments, the image of the human face is extracted using one or more classifiers that can detect a human face within an image. However, alternative techniques for isolating faces from an image can also be utilized. In several embodiments, the process of identifying a facial expression involves using PCA to define a space of human faces and facial expressions using a training data set containing multiple images of human faces and multiple images of human facial expressions. The PCA space can then be utilized to identify the facial expression that most closely corresponds to the appearance of a human face isolated from an image.

In several embodiments, identifying a facial expression involves finding the feature vector from the PCA space that provides the best match to a detected face. The feature vector from the PCA space of faces and facial expressions can then be mapped to a facial expression of a 3D character. Any of a variety of mappings to virtual facial expressions (i.e. expressions of 3D characters) can be utilized including (but not limited to) simply mapping categories of human facial expression to specific virtual facial expressions can be utilized, or mapping the PCA space of human faces directly to the facial expression controllers of the 3D character. In a number of embodiments, the mapping is performed by mapping the PCA space of human faces and facial expressions to a PCA space of facial expressions for the 3D character. In other embodiments, any of a variety of mappings appropriate to the requirements of a specific application can be utilized. Systems and methods for generating facial expressions for 3D characters corresponding to facial expressions captured in images of human performers in accordance with embodiments of the invention are discussed further below.

### System Architecture for Generating Facial Expressions for 3D Characters

Facial expressions for 3D characters in accordance with many embodiments of the invention can be generated by a processor from a frame of video or an image captured by a camera connected to a computing device. Processors resident upon a computing device or a server connected to a network can receive the image, detect a face within the image, detect a facial expression within the face and apply the facial expression to a 3D character. In several embodiments, the detection of faces and facial expressions can leverage information across multiple frames of video. In this way, information with respect to a detected face from a previous frame can be used to improve the robustness of face detection and to increase the speed and/or accuracy with which expression is detected. In many embodiments, the processor detects a facial expression by determining a feature vector from a PCA space of human faces and human facial expressions that synthesizes a face that most closely matches the detected face. The feature vector of the PCA space of human faces and facial expressions can then be mapped to a facial expression for a 3D character to generate a facial expression for a 3D character. As is discussed further below, one approach for mapping facial expressions to 3D character facial expressions is to obtain a PCA space of 3D character facial expressions and define mappings between the two PCA spaces. In other embodiments, any of a variety of techniques can be used to map expressions identified in the PCA space of human faces and facial expressions to virtual facial expressions for a 3D character.

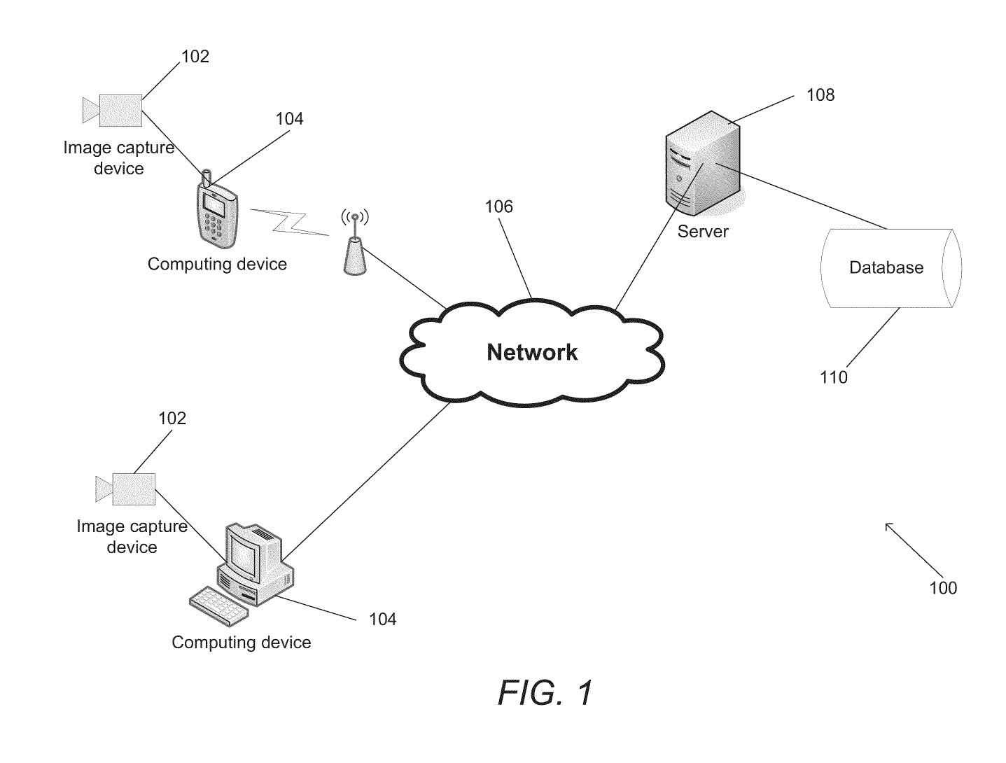

A system for animating the faces of 3D characters using images of human faces utilizing an animation server in accordance with an embodiment of the invention is illustrated in FIG. 1. Image capture devices 102 can be connected with computing devices 104. These computing devices 104 can be connected via a network 106, such as (but not limited to) the Internet, to a server 108 that maintains a database 110 including a training data set (which may be registered to points and/or features within a 2D or a 3D template image) on which PCA is run to determine the principal components of the training set. In many embodiments, image capture devices 102 are able to capture images that include a human face. In several embodiments, the computing device 104 provides the captured image to a server 108 over a network 106. The server 108 can determine the feature vector from the PCA space of human faces and human facial expressions that provides the best match to the detected face from the captured image. The feature vector describing the facial expression can then be mapped to a facial expression for a 3D character to generate a corresponding facial expression for the 3D character.

In numerous embodiments, a computing device can animate the faces of 3D character using images of human faces with processes running locally on a computing device without a network connection.

In several embodiments, the facial expression of a 3D character generated from an image of a human face need not reflect or correspond to any human facial expression from the human face but can be an arbitrary facial expression. Furthermore, the PCA space of human faces and facial expressions can be mapped to any aspect of a 3D character to animate the 3D character using observed facial expressions.

Although specific systems for animating the faces of 3D characters using images of human faces are discussed above, systems that animate the faces of 3D character using images of human faces can be implemented in a variety of ways that are appropriate to the requirements of specific applications in accordance with embodiments of the invention.

Applying Facial Expressions to 3D Characters from a Captured Image

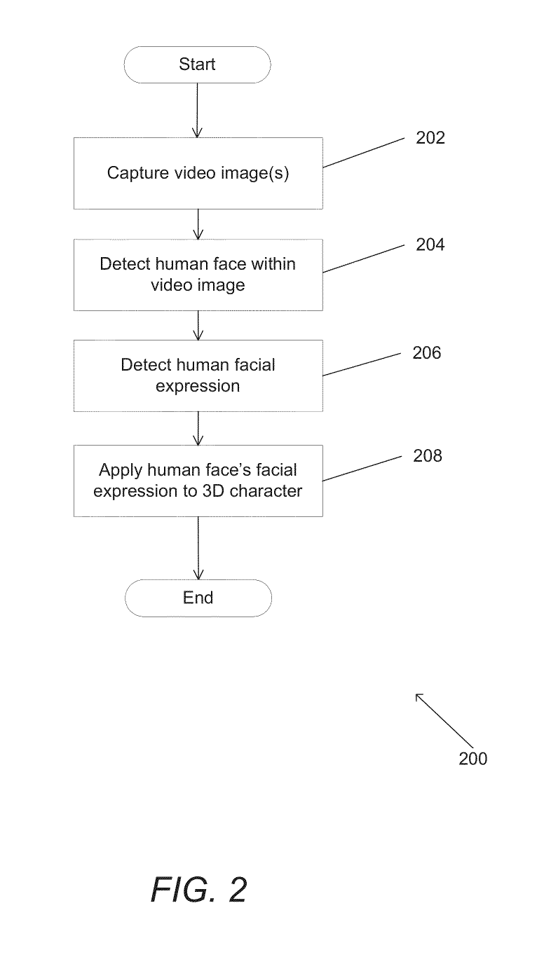

Facial expressions detected from faces isolated from images can be utilized to apply facial expressions to 3D characters. A flow chart illustrating a process of animating a face of a 3D character using images of a human face in accordance with an embodiment of the invention is illustrated in FIG. 2. The process 200 includes capturing (202) at least one image. A human face can be identified (204) within the image and a human facial expression can be detected (206) based upon the identified human face. The detected facial expression can then be mapped (206) to a virtual facial expression for a 3D character.

In many embodiments, a human face and human facial expression can be identified using a single image. In many embodiments, multiple frames of a video sequence can be utilized to identify and/or track a human face and human facial expression. Utilization of multiple images of the same human face can yield more robust results as more data from across a number of images is provided and can be extracted for the tracked human face. In addition, motion vectors within compressed video can assist with the tracking of faces once they are located.

Although specific processes for applying facial expressions to 3D characters based upon captured images are discussed above, a variety of processes can be utilized to apply facial expressions to 3D characters that are appropriate to the requirements of specific applications in accordance with embodiments of the invention. Processes for detecting human faces within images are discussed further below.

Detecting a Human Face within an Image

Processes for detecting human faces within images in accordance with embodiments of the invention can involve identifying an area of an image that is indicative of a human face. In several embodiments, a cascade of classifiers operating on an image is utilized to detect a human face from within the image. Various different human face detection methods are discussed in P. Viola, M. Jones, Robust Real-time Object Detection, IJCV 2001, the disclosure of which is hereby incorporated by reference in its entirety.

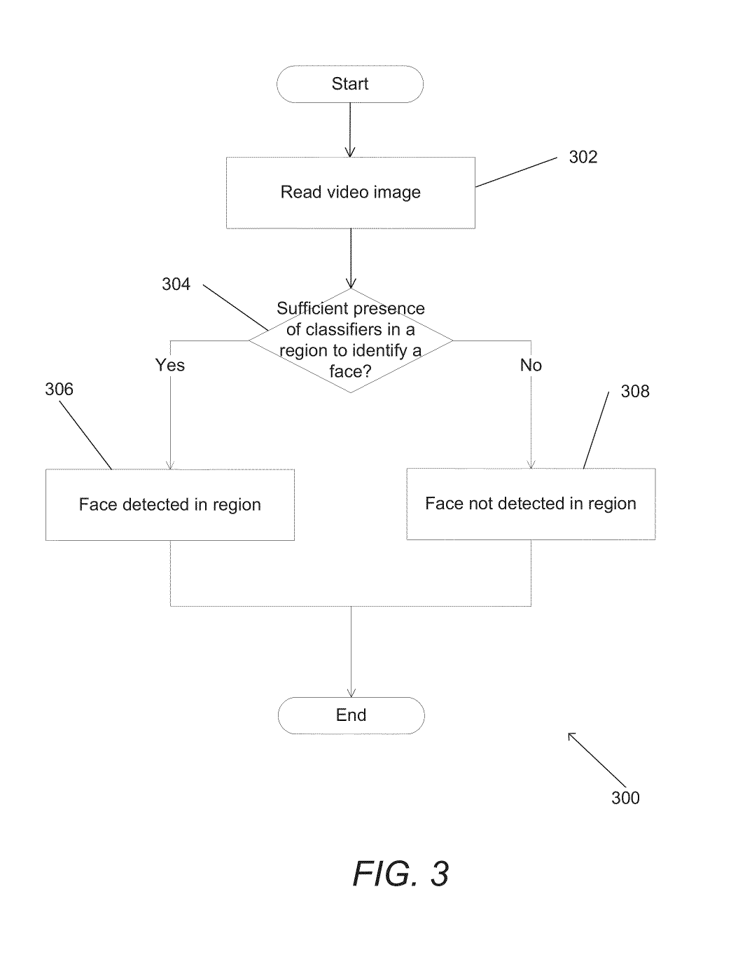

A flow chart illustrating a process for detecting a human face in accordance with an embodiment of the invention is illustrated in FIG. 3. The process 300 includes reading (302) an image or a sequence of images. In several embodiments, a conventional RGB video camera is used to capture the images and each raw video frame undergoes several image enhancement steps such as, but not limited to, gamma correction, histogram equalization, and shadow recovery. In other embodiments, any of a variety of image enhancement process that enhance the overall quality of the input image and increase the robustness of subsequent facial expression detection processes within a variable range of lighting conditions and video capture hardware can be utilized. Upon reading (302) the image, a decision (304) is made as to whether there is a sufficient presence of classifiers in a region to identify a face. If there are sufficient classifiers, then a face is detected (306) in the region and the process ends. If there are insufficient classifiers in the region, then a face is not detected (308) in the region and the process ends.

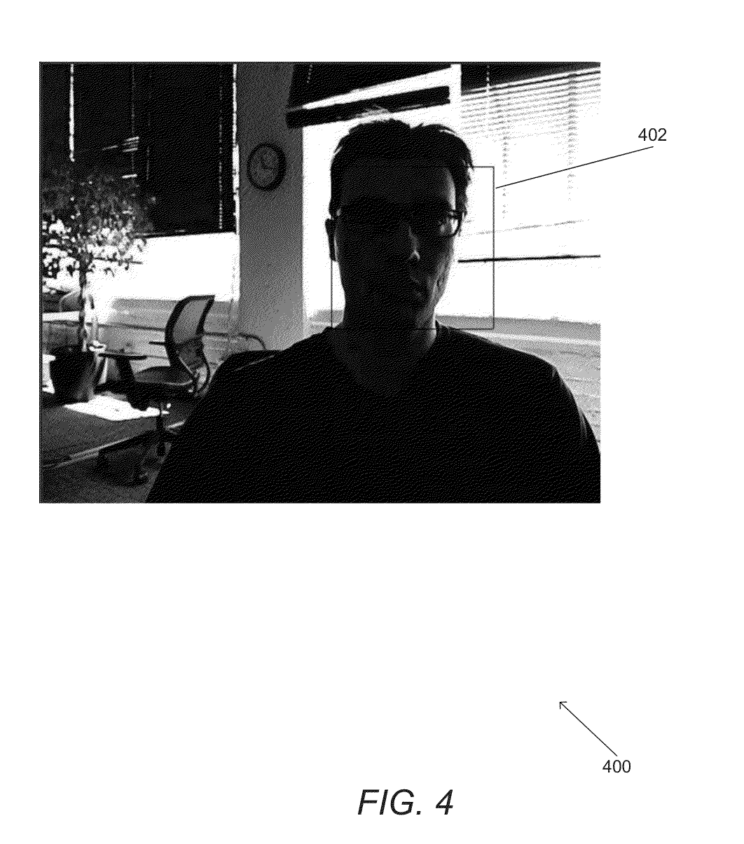

In many embodiments, images are part of a video stream generated from a video camera. A captured image with a human face is illustrated in FIG. 4. The captured image 400 includes a face indicated in a boxed region 402. In certain embodiments, a region can be manually noted as likely to contain a face to reduce the computational resources required to identify a face in an image.

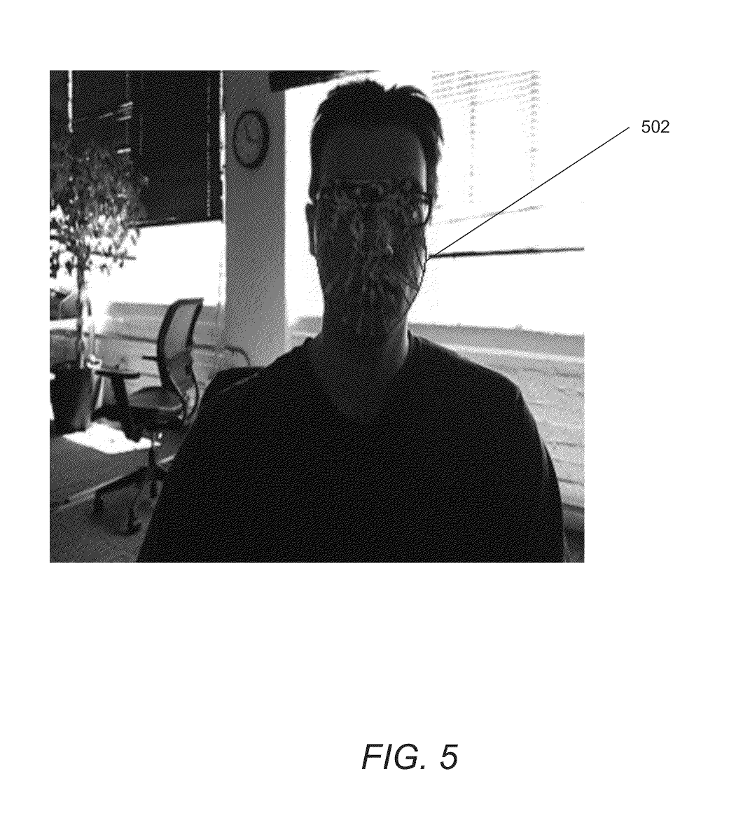

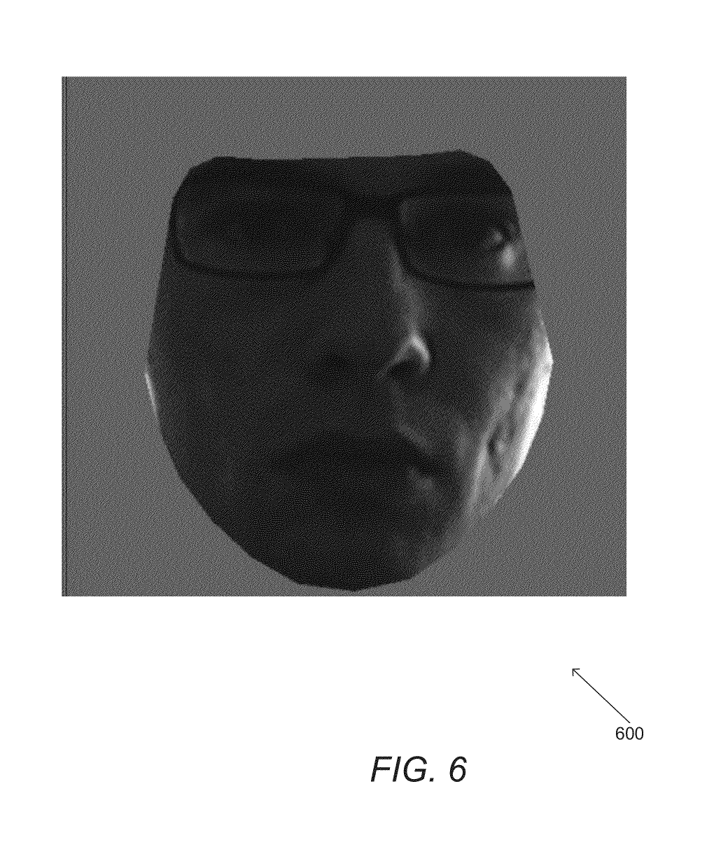

A cascade of classifiers may be utilized to determine if there are sufficient classifiers in a particular region of an image to indicate the presence of a face. In several embodiments, a decision concerning whether a face is present is made as to whether there are sufficient classifiers within a region of the image. A face from within the image of FIG. 4 detected using a cascade of classifiers is illustrated in FIG. 5. A region 502 of the image, which includes the face, is bounded by lines. The captured face 600 shown in FIG. 6 is isolated from the rest of the image to localize the area of the image analyzed to extract human facial expressions. Processes for isolating faces from images are discussed further below.

In certain embodiments, multiple human faces can be detected in a single image. The multiple human faces can also each have a unique signature that enables tracking of the human faces throughout different images, such as different frames of video and/or different views of the scene. Facial expressions of each of the detected human faces can be extracted to animate the facial expression of one or more 3D characters.

Although specific processes for detecting human faces from captured images are discussed above, a human face can be detected from a captured video utilizing any of a variety of processes that are appropriate to the requirements of a specific application in accordance with embodiments of the invention. Processes for generating facial expressions for 3D characters in accordance with embodiments of the invention are discussed further below.

### Generating Facial Expressions for a 3D Character

Facial expressions can be applied to 3D characters in accordance with many embodiments of the invention by identifying a human facial expression in an image and mapping the human facial expression to a facial expression of the 3D character. In several embodiments, human facial expressions can be identified by locating the feature vector in a PCA space of human faces and human facial expressions that is closest to the human facial expression found in an image.

A description of the space of human faces and facial expressions can be found by performing PCA with respect to a training set of human faces and facial expressions that are registered with respect to points and/or features of a template image. In many embodiments, a training set can include a set of 2D images or 3D images, where the 3D images could include additional metadata including (but not limited to) depth maps. The 3D images contain more information concerning the geometry of the faces in the training dataset. Therefore, defining a PCA space of human faces and facial expressions using 3D geometry information and texture information can be more challenging. Depending upon the training data, the PCA can construct a description of the space of human faces and facial expressions in 2D and/or in 3D. In addition, the training data for human facial expressions can include images of human facial expressions at slight angles relative to the camera to increase the robustness of the detection of a human facial expression, when a human performer is not looking directly at the camera.

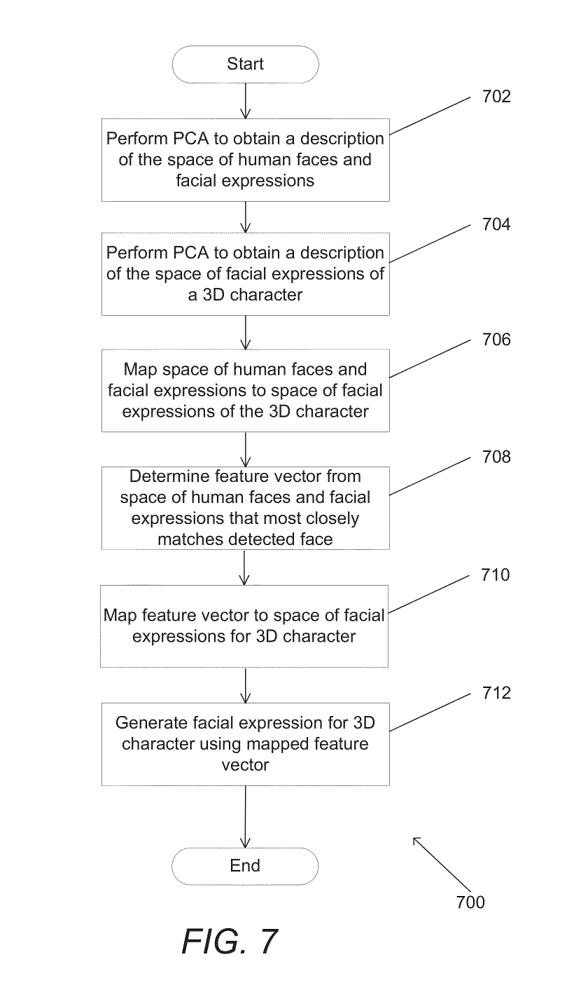

A flow chart illustrating a process of generating a facial expression for a 3D character in accordance with an embodiment of the invention is illustrated in FIG. 7. The process 700 includes performing (702) PCA to obtain a description of the space of human faces and facial expressions. The process 700 also includes performing (704) PCA to obtain a description of the space of facial expressions of a 3D character. In certain embodiments, performing (704) PCA to obtain a description of the space of facial expression of a 3D character is not performed. As an alternative to generating a description of the space of facial expressions of a 3D character, a discrete set of facial expressions of can be utilized, the feature vector can be projected into the facial expression controls (such as but not limited to blend shapes controller parameters) of the 3D character, or a template image used in the definition of the PCA space of human faces and facial expressions can be applied to the 3D character face and the feature vector applied directly to the template image. After performing PCA to obtain a description of the relevant spaces, a set of mappings is defined that maps the space of human facial expressions is mapped (706) to the space of facial expressions of the 3D character. Mappings can include linear, non-linear or a combination of linear and non-linear mappings. After the mappings are generated, the feature vector from the space of human faces and facial expressions that most closely matches a detected face is determined (708). The most closely matching feature vector can then be mapped (710) to a facial expression for the 3D character using the mappings to generate (712) the face of a 3D character including a corresponding facial expression to the human facial expression captured in the image. In the illustrated embodiment, the mapping is between PCA spaces although alternative mappings can also be utilized as appropriate to the requirements of specific applications in accordance with embodiments of the invention.

Although specific processes for generating facial expressions for a 3D character are discussed above, processes that generate facial expressions for a 3D character can be implemented in a variety of ways that are appropriate to the requirements of a specific application in accordance with embodiments of the invention. Processes for obtaining a description of the space of human faces and facial expressions using PCA in accordance with embodiments of the invention are discussed further below.

### Obtaining a Description of the Space of Human Facial Expressions

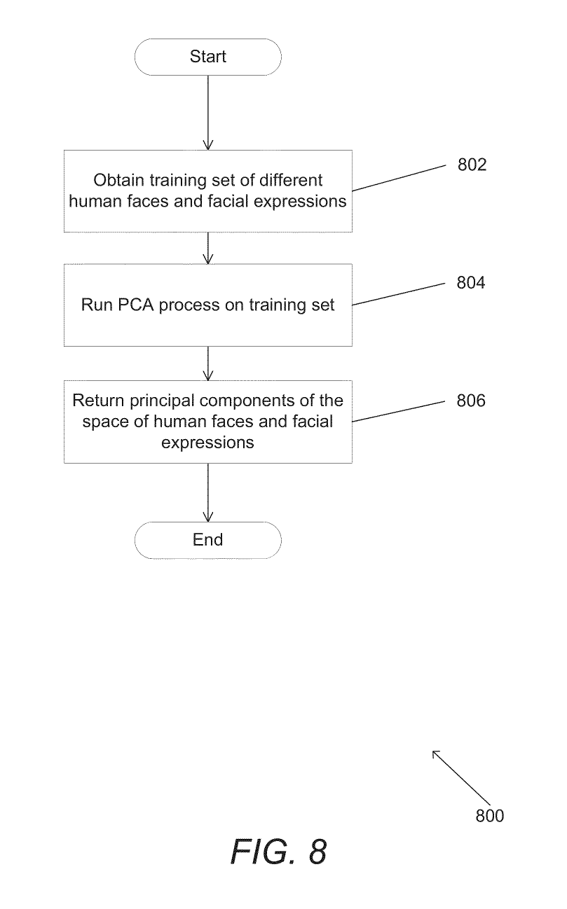

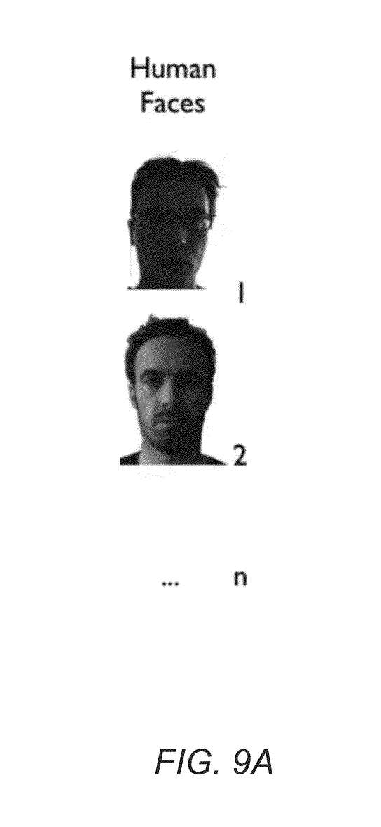

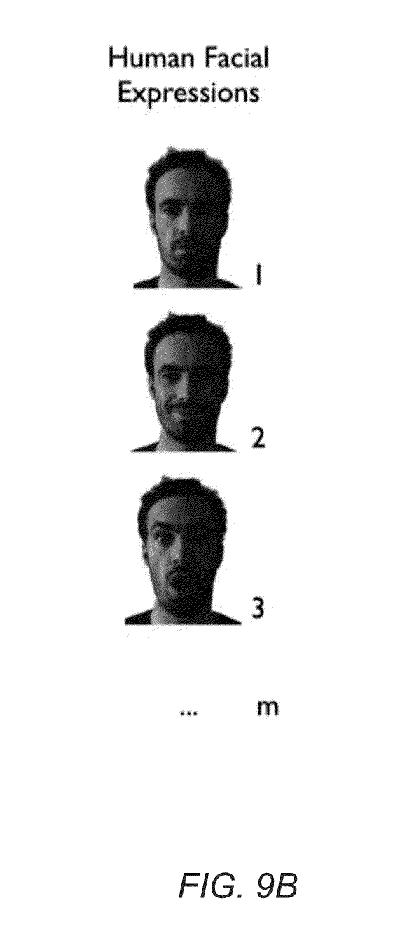

A description of the space of human facial expressions in accordance with many embodiments can be obtained performing PCA on a training set of human faces and human facial expressions. A flow chart illustrating a process of performing PCA to obtain a description of the space of human faces and facial expressions in accordance with an embodiment of the invention is illustrated in FIG. 8. The process 800 includes obtaining (802) a training set of different human faces (see FIG. 9A) and a training set of different human facial expressions (see FIG. 9B). PCA can be run (804) on the training set to return (806) the principal components describing the space of human faces and facial expressions. A more robust description of the space of human facial expressions can be developed with a greater number and diversity of the human faces and facial expressions that make up the training set(s).

In several embodiments, various different PCA techniques may be utilized to determine the space of human faces and facial expressions such as (but not limited to) Kernel Principal Component Analysis. Similarly, the space of human faces and facial expressions may be determined through PCA techniques and the utilization of Active Appearance Models (AAM) in which a the statistics of a training data set are used to build an active appearance model and the active appearance model used to synthesize an image of a face that is the closest match to a new image of a face by minimizing a difference vector between the parameters of the synthesized image and the new image. Various techniques for utilizing AAM are discussed in T. F. Cootes, G. J. Edwards, C. J. Taylor, Active appearance models, ECCV 1998, the disclosure of which is hereby incorporated by reference in its entirety. In certain embodiments, the parameterization of a face shape, expression and orientation is achieved using 3 sets of parameters: (1) scale and position of the face in the input image (3 scalars); (2) a descriptor of the geometric component (a vector of a chosen size of coefficients describing the subject face geometry, for example, as a sum of facial geometry eigenvectors); and (3) a descriptor of the texture component (a vector of a chosen size of coefficients describing the subject facial texture, for example, as a sum of facial texture eigenvectors). In other embodiments, any of a variety of sets of parameters can be utilized to parameterize human facial shape, expression and orientation in accordance with embodiments of the invention.

In several embodiments of the invention, several approaches based on completely different tracking strategies are combined. In a number of embodiments of the invention, a facial animation application executes a multiple image patches detection process in conjunction with PCA based tracking and the results of both processes are combined in a Bayesian way to provide increased robustness and accuracy. The multiple image patches detection process tries to identify pre-learned patches of the human face on the source video image every frame or in predetermined frames in a sequence of frames. In several embodiments, a multiple image patches detection process extracts patches of different sizes from a training data set and can scale the patches to the same size to account for faces that appear closer or further away than faces in the training data set. The patches can then be utilized to detect the characteristics of a face and matching patches can be utilized to detect human facial expressions that can be used to drive the animation of a 3D character. In a number of embodiments, PCA can be performed on the patches to describe a vector space of the patches. In certain embodiments, different processes are applied to perform facial tracking at adaptive frame rates based upon the available CPU and/or GPU computational capacity.

Although specific processes for obtaining a description of the space of human facial expressions are discussed above, processes for describing the space of human facial expressions can be implemented in a variety of ways that are appropriate to the requirements of a specific application in accordance with embodiments of the invention. Obtaining a description of the space of 3D character facial expressions is discussed further below.

### Obtaining a Description of the Space of 3D Character Facial Expressions

A description of the space of 3D character facial expressions in accordance with many embodiments can be obtained by performing PCA on a training set of 3D character facial expressions. In several embodiments, various facial expressions for a 3D character can be generated manually by creating blend shapes of a 3D character face. In other embodiments, a training data set can be obtained using any of a variety of techniques appropriate to the requirements of a specific application.

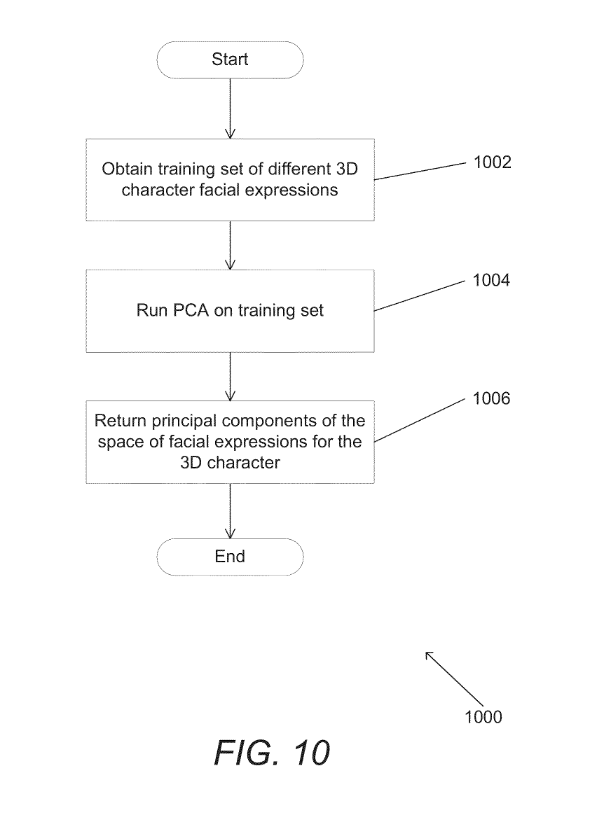

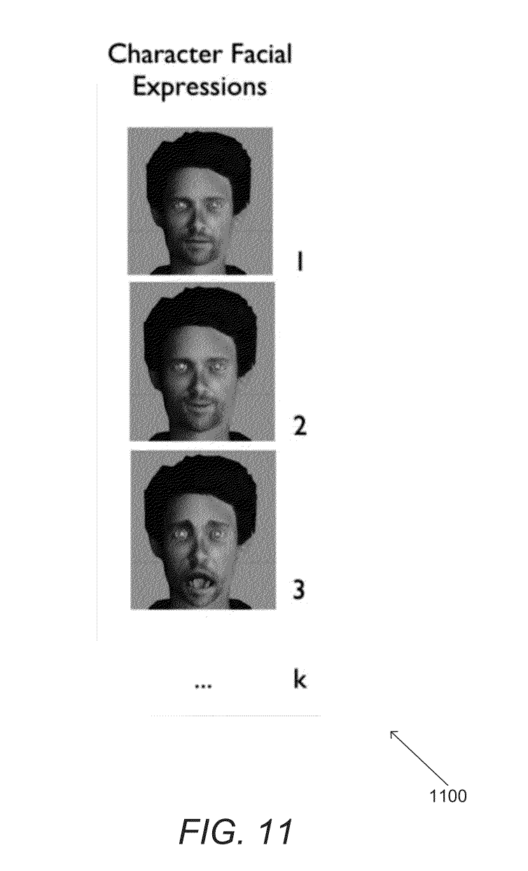

A flow chart illustrating a process of performing PCA to obtain a description of the space of 3D character facial expressions in accordance with an embodiment of the invention is illustrated in FIG. 10. The process 1000 includes obtaining (1002) a training set of different 3D character facial expressions. PCA can be run (1004) on the training set to return (1006) a description of the space of 3D character facial expressions as the principal components of the space of 3D character facial expressions. A training set that can be utilized to obtain a description of the space of 3D character facial expressions is illustrated in FIG. 11. The training set 1100 includes numerous different 3D character facial expressions. A more robust description of the space of 3D character facial expressions can be developed with a greater number and diversity of the 3D character facial expressions that make up the training set.

Although a process for obtaining a description of the space of 3D character facial expressions is discussed above, processes for describing the space of 3D character facial expressions can be implemented in a variety of ways as appropriate to the requirements of a specific application in accordance with embodiments of the invention. Processes for mapping expressions from a captured image of a human performer to an expression for a 3D character involve determining the synthesized face from the PCA space of human faces and facial expressions that most closely matches the face in the captured image. Processes for determining the feature vector from the PCA space of human faces and facial expressions that is the best match for a face in a captured image are discussed below.

Determining the Feature Vector that Most Closely Matches a Human Face

In many embodiments, the process of detecting a facial expression on a face identified within an image involves determining the feature vector from a PCA space of human faces and facial expressions that most closely matches the human face detected within the image. The space of human faces and human facial expressions can be learned by separating the geometry and texture components of human faces. In many embodiments, the feature vector is a combination of a descriptor of the geometric component of the face (i.e. a vector of a chosen size of coefficients describing facial geometry, for example, as the sum of facial geometry eigenvectors) and a descriptor of a texture component of the face (i.e. a vector of a chosen size of coefficients describing the subject facial texture, for example, as a sum of facial eigenvectors). The feature vector that is the best match can be found by scaling and positioning the face extracted from the captured image with respect to a template image and then finding the geometric and texture components of the feature vector within the PCA space of human faces and facial expressions that most closely corresponds to the scaled face.

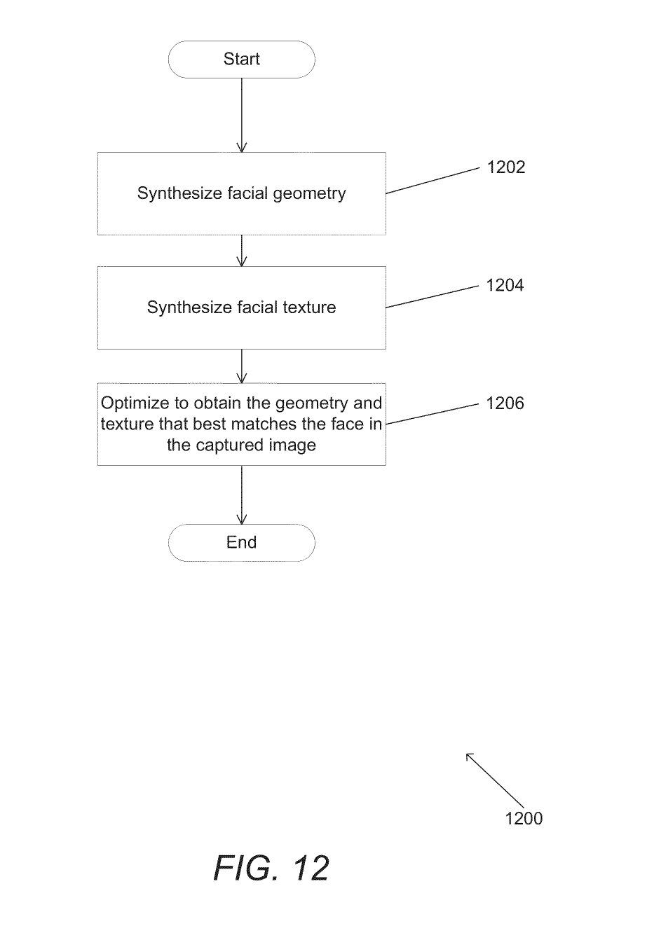

A process for determining the feature vector that most closely matches a human face in accordance with an embodiment of the invention is illustrated in FIG. 12. The process 1200 includes synthesizing (1202) a facial geometry from an estimate of face position/size and geometry within the captured image. A facial texture is then synthesized (1204) on a defined reference facial geometry using an estimate of the facial texture based upon the captured image. Optimization (1206) of the synthesized geometries and textures can then be performed based upon any of a variety of matching criteria to obtain the geometry and texture that best matches the face in the captured image. In several embodiments, a similarity function (to maximize criteria indicating similarity) or a distance function (to minimize criteria not indicating similarity) are optimized to obtain the geometry and texture that is the best match. Depending upon whether the captured image includes 2D or 3D information, an appropriate 2D or 3D template image can be utilized to determine facial geometry.

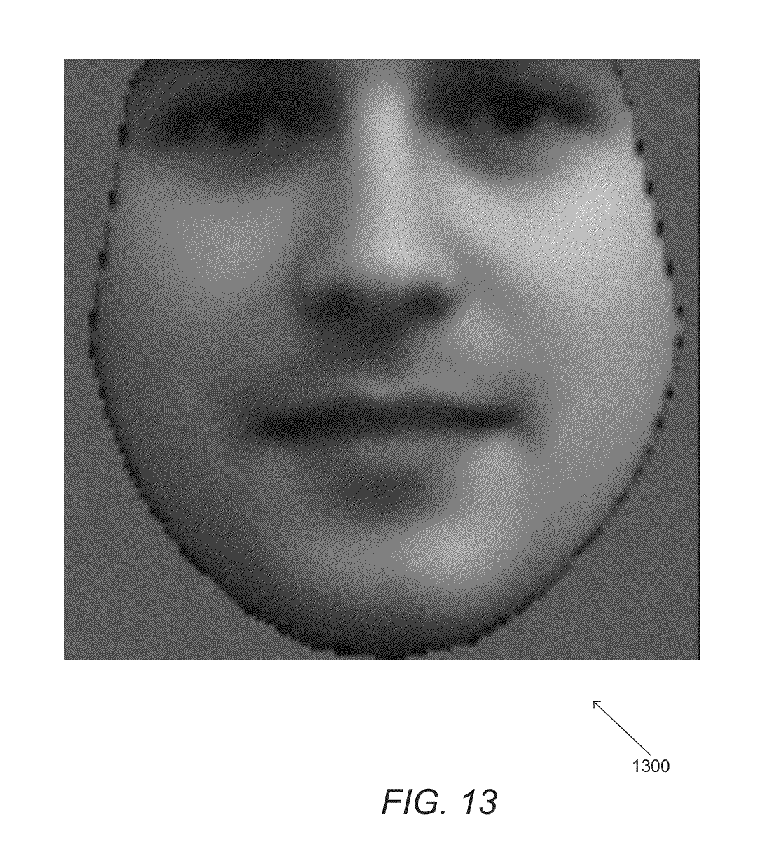

A synthesized face with a geometry and facial texture found within the PCA space of human faces and facial expressions that is the best match for the isolated face shown in FIG. 6 is illustrated in FIG. 13. The face 1300 is similar to but not exactly like the face of FIG. 6. The face 1300 is, however, the face determined to be the best match within the PCA space of human faces and facial expressions to the face shown in FIG. 6. As discussed above, when the feature vector in a PCA space of human faces and facial expressions that most closely matches the face in a captured image is determined, the feature vector can be mapped to an expression for a 3D character to apply the corresponding facial expression to the face of the 3D character.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A system for animating a 3D character model, comprising:
a processor; and
storage containing:
a 3D character model comprising a 3D mesh including a face;
a description of a space of human faces and facial expression obtained using a training data set containing multiple images of human faces registered to a template image of a human face and multiple images of human facial expressions registered to the same template image of a human face;
a set of mappings from the space of human faces and facial expressions to a plurality of facial expressions for the 3D character model, where the plurality of facial expressions each represent a deformation of the mesh of the 3D character model; and
a facial animation application;
wherein the facial animation application configures the processor to:
receive at least one image;
extract an image of a human face from an image;
match an extracted image of a human face to a point in the space of human faces and facial expressions using the description of a space of human faces and facial expressions;
select a facial expression for the 3D character based upon a point in the space of human faces and facial expressions matching an extracted image of a human face and the set of mappings from the space of human faces and facial expressions to the plurality of facial expressions for the 3D character model; and
deform the mesh of the 3D character based upon a selected facial expression.

2. The system of claim 1, wherein the storage further comprises a cascade of classifiers and the facial animation application configures the processor to extract an image of a human face from an image by using the cascade of classifiers to identify an image of a human face within the image.

3. The system of claim 1, wherein the description of a space of human faces and facial expression is obtained by performing Principal Component Analysis (PCA) of a training data set containing multiple images of human faces registered to a template image of a human face and by performing PCA of multiple images of human facial expressions registered to the same template image of a human face to define a vector space of human faces and human facial expressions.

4. The system of claim 3, wherein the facial animation application configures the processor to match an extracted image of a human face to a point in the space of human faces and facial expressions using the description of a space of human faces and facial expressions by locating a vector within the space of human faces and human facial expressions that synthesizes an image of a human that is the closest match to the extracted image of a human face in accordance with at least one matching criterion.

5. The system of claim 4, wherein the facial animation application configures the processor to parameterize the extracted image of a human face with respect to:
the scale and position of the extracted image of a human face;
the geometry of the extracted image of a human face; and
the texture of the extracted image of a human face.

6. The system of claim 5, wherein the facial animation application configures the processor to parameterize the scale and position of the extracted image of a human face using a plurality of scalar measurements.

7. The system of claim 5, wherein the facial animation application configures the processor to parameterize the geometry of the extracted image of a human face using a vector of a chosen size of coefficients describing the subject face geometry.

8. The system of claim 5, wherein the facial animation application configures the processor to parameterize the texture of the extracted image of a human face using a vector of a chosen size of coefficients describing the subject facial texture.

9. The system of claim 5, wherein synthesizing an image of a human face comprises:
synthesizing a facial geometry based upon the parameterization of the scale, position and geometry of the extracted image of a human face;
synthesizing a facial texture on a defined reference facial geometry using an estimate of the facial texture based upon extracted image of a human face; and
determining a combination of a synthesized geometry and a synthesized texture that provide the closest match to the extracted image of the human face in accordance with the at least one matching criterion.

10. The system of claim 9, wherein the at least one matching criterion is a similarity function.

11. The system of claim 9, wherein the at least one matching criterion is a distance function.

12. The system of claim 4, wherein the facial animation application configures the processor to synthesize images of a human face using vectors from the space of human faces and facial expressions based upon an active appearance model generated using the training data set.

13. The system of claim 4, wherein the storage further comprises:
a description of a vector space of virtual facial expressions for the 3D character model obtained by performing PCA on a training data set containing a plurality of facial expressions each representing a deformation of the mesh of the 3D character model;
wherein the set of mappings from the space of human faces and facial expressions to a plurality of facial expressions for the 3D character model comprises a set of mappings from the vector space of human faces and facial expressions to the vector space of virtual facial expressions for the 3D character model.

14. The system of claim 4, wherein the facial animation application configures the processor to:
match an extracted image of a human face to a point in the space of human faces and facial expressions using the description of a space of human faces and facial expressions and perform a multiple image patches detection process to multiple image patches detection process detect a human face and facial expression; and
perform a Bayesian combination of the results of matching the extracted image of a human face to a space of human faces and facial expressions and the human face and facial expression detected using the multiple image patches detection process.

15. The system of claim 1, wherein the training data set comprises a set of two dimensional images of human faces.

16. The system of claim 15, wherein the training data set further comprises depth maps for a plurality of the set of two dimensional images.

17. The system of claim 15, wherein the training data set comprises multiple views of each human face.

18. The system of claim 17, wherein the multiple views image the human face from different angles.

19. The system of claim 1, wherein the storage further comprises:
a description of a space of virtual facial expressions for the 3D character model;
wherein the set of mappings from the space of human faces and facial expressions to a plurality of facial expressions for the 3D character model comprises a set of mappings from the space of human faces and facial expressions to the space of virtual facial expressions for the 3D character model.

20. The system of claim 19, wherein the space of virtual facial expressions for the 3D character model is obtained from a training data set of containing a plurality of facial expressions each representing a deformation of the mesh of the 3D character model.

21. The system of claim 1, wherein the facial animation application configures the processor to:
receive at least one image in the form of a sequence of video frames including a first frame of video and a second frame of video; and
utilize the extracted image of a human face from the first video frame to extract an image of a human face from the second video frame.

22. The system of claim 21, wherein the facial animation application further configures the processor to utilize the point in the space of human faces and facial expressions found to match an extracted image of a human face from the first video frame to locate a point in the space of human faces and facial expressions matching an extracted image of a human face from the second frame of video.

23. The system of claim 21, wherein the sequence of video frames is compressed and includes motion vector information and the facial animation application configures the processor to:
parameterize an extracted image of a human face with respect to the position of the extracted image of a human face in the first frame of video; and
parameterize an extracted image of a human face with respect to the position of the extracted image of a human face in the second frame of video using the motion vector information.

24. The system of claim 1, wherein the facial animation application configures the processor to control the deformation of the 3D mesh of the 3D character using a plurality of blend shape control parameters.

25. The system of claim 24, wherein the set of mappings from the space of human faces and facial expressions to a plurality of facial expressions for the 3D character model comprise a set of mappings from the space of human faces and facial expressions to specific configurations of the plurality of blend shape control parameters.

26. A method for animating a 3D character model comprising:
receiving at least one image at an animation system, where a portion of the image includes an image of a human face;
extracting the image of the human face from at least one received image using the animation system;
matching the extracted image of a human face to a point in a space of human faces and facial expressions based upon a description of a space of human faces and facial expressions obtained using a training data set containing multiple images of human faces registered to a template image of a human face and multiple images of human facial expressions registered to the same template image of a human face using the animation system;
selecting a facial expression for a 3D character based upon the point in the space of human faces and facial expressions matching the extracted image of a human face and a set of mappings from the space of human faces and facial expressions to a plurality of facial expressions for the 3D character model using the animation system, where the 3D character model comprises a 3D mesh including a face and the plurality of facial expressions in the set of mappings each represent a deformation of the mesh of the 3D character model; and
deforming the mesh of the 3D character based upon the selected facial expression using the animation system.
